(19) United States
(12) Patent Application Publication
(10) Pub. No.: US 2017/0168346 A1
(43) Pub. Date: Jun. 15, 2017

(54) DISPLAY DEVICE AND MANUFACTURING METHOD THEREOF

(71) Applicant: SAMSUNG DISPLAY CO., LTD., Yongin-si (KR)

(72) Inventors: Bum Soo KAM, Yongin-si (KR); Hoon KANG, Suwon-si (KR); Chong Sup CHANG, Hwaseong-si (KR)

(21) Appl. No.: 15/195,858

(22) Filed: Jun. 28, 2016

(30) Foreign Application Priority Data
Dec. 11, 2015 (KR) 10-2015-0177428

(51) Int. Cl. G02F 1/1333; G02F 1/1339; G02F 1/1341; G02F 1/1368; G02F 1/1335

(52) U.S. Cl. CPC G02F 1/133377; G02F 1/1368; G02F 1/133345; G02F 1/133512; G02F 1/1341; G02F 1/1339; G02F 2201/123; G02F 2202/02

(57) ABSTRACT

A display device according to an exemplary embodiment includes: a substrate; a thin film transistor provided above the substrate; a pixel electrode connected with the thin film transistor; an insulating layer provided between the thin film transistor and the pixel electrode; a trench provided in a portion of the insulating layer; a light blocking member provided in in the trench; a roof layer provided above the pixel electrode to be separated from the pixel electrode, interposing a plurality of microcavities therebetween; a liquid crystal layer provided in the microcavities; and encapsulation layer covering the microcavities.

### RELATED APPLICATIONS

This application claims priority to and the benefit of Korean Patent Application No. 10-2015-0177428 filed in the Korean Intellectual Property Office on Dec. 11, 2015, the disclosure of which is incorporated by reference in its entirety.

### BACKGROUND

1. Field

The present disclosure relates generally to a display device and a manufacturing method thereof, more particularly, to a display device that facilitates smooth injection of liquid crystal materials, and a manufacturing method thereof.

2. Description of the Related Art

As one of the most commonly used flat display devices, a typical liquid crystal display device includes two display panels where field-generating electrodes such as a pixel electrode, a common electrode, and the like are formed, and a liquid crystal layer provided between the two display panels. The liquid crystal display device generates an electric field in the liquid crystal layer by applying a voltage to the field-generating electrodes, determines a direction of liquid crystal molecules of the liquid crystal layer by the electric field, and controls polarization of incident light to display an image.

The two display panels of the liquid crystal display device may include a thin film transistor array panel and an opposing display panel. In the thin film transistor array panel, a gate line transferring a gate signal and a data line transferring a data signal are formed to cross each other, a thin film transistor connected with the gate line and the data line, a pixel electrode connected with the thin film transistor, and the like may be formed. In the opposing display panel, a light blocking member, a color filter, a common electrode, and the like may be formed. In some cases, the light blocking member, the color filter, and the common electrode may be formed on the thin film transistor array panel.

In a liquid crystal display device including two substrates, respective constituent elements are formed on the two substrates. As a result, the liquid crystal display device becomes heavy, thick, and costly, and requires a long processing time.

The above information disclosed in this Background section is only for enhancement of understanding of the background information of the described technology and therefore it may contain information that does not form a prior art that is already known to a person of ordinary skill in the art.

### SUMMARY

The present disclosure provides a display device that can be manufactured using a single substrate, thereby reducing the weight, thickness, cost, and processing time, and a method for manufacturing the same.

In a display device including a single substrate, a plurality of microcavities is formed and a liquid crystal material is injected into the microcavities through injection holes. When the size of the injection holes becomes small, the liquid crystal material cannot be efficiently injected. The present disclosure provides a display device in which a liquid crystal material can be efficiently injected, and a method for manufacturing the same.

A display device according to an exemplary embodiment includes: a substrate; a thin film transistor provided above the substrate; a pixel electrode connected with the thin film transistor; an insulating layer provided between the thin film transistor and the pixel electrode; a trench provided in a portion of the insulating layer; a light blocking member provided in the trench; a roof layer provided above the pixel electrode to be separated from the pixel electrode, interposing a plurality of microcavities therebetween;

a liquid crystal layer provided in the microcavities; and encapsulation layer covering the microcavities.

The insulating layer may be made of an organic insulating material.

The display device may further include a first region provided between microcavities that are adjacent to each other along a column direction and a second region provided between microcavities that are adjacent to each other along a row direction. The trench may be provided in the first region.

A first height of the trench may be lower than a second height of the insulating layer that overlaps the microcavities.

A first thickness of the insulating layer where the trench is formed may be thicker than a second thickness of the insulating layer where the trench is not formed.

A ratio of the first thickness to the second thickness of the insulating layer may be 20% or more and 90% or less.

A depth of the trench may be 0.5 μm or more and 5μm or less.

An upper surface of the insulating layer and an upper surface of the light blocking member may be planarized.

A first height of the upper surface of the light blocking member may be lower than or equal to a second height of the upper surface of a portion of the insulating layer that overlaps the microcavities.

The light blocking member may include a negative photoresist.

Another exemplary embodiment provides a method for manufacturing a display device. The method includes: forming a thin film transistor on a substrate;

forming an insulating layer on the thin film transistor; forming a trench by patterning a portion of the insulating layer; forming a pixel electrode on the insulating layer, wherein the pixel electrode is connected with the thin film transistor; forming a light blocking member in the trench; forming a sacrificial layer on the insulating layer, the pixel electrode, and the light blocking member; forming a roof layer on the sacrificial layer;

forming injection holes that partially expose the sacrificial layer by patterning the roof layer; forming microcavities between the pixel electrode and the roof layer by eliminating the sacrificial layer; forming a liquid crystal layer by injecting a liquid crystal material into the microcavities through the injection holes; and sealing the microcavities by forming an encapsulation layer on the roof layer.

The forming the light blocking member in the trench may include: forming the light blocking member on the insulating layer and the pixel electrode; and developing the light blocking member.

The light blocking member may be developed until the light blocking member remains only in the trench.

The light blocking member may be developed until the light blocking member disposed outside of the trench is eliminated.

In the forming of the light blocking member in the trench, the light blocking member may be developed without undergoing an exposure process.

The light blocking member may include a negative photoresist.

The insulating layer may be made of an organic insulating material.

The display device may further include a first region provided between microcavities that are adjacent to each other along a column direction and a second region provided between microcavities that are adjacent to each other along a row direction. The trench may be provided in the first region.

A first height of the trench may be lower than a second height of the insulating layer that overlaps the microcavities.

A ratio of a first thickness of the insulating layer where the trench is formed to a second thickness of the insulating layer where the trench is not formed may be 20% or more and 90% or less.

The display device and the method for manufacturing the display device according to the exemplary embodiments of the prevention disclosure have the following effects.

The display device can be manufactured using a single substrate such that weight, thickness, cost, and processing time can be reduced.

Further, the trench is formed in the insulating layer, and the light blocking member is formed in the trench so that a liquid crystal material can be efficiently injected into the microcavities.

### BRIEF DESCRIPTION OF THE DRAWINGS

FIG. 1 is a top plan view of a display device, according to an exemplary embodiment.

FIG. 2 is an equivalent circuit diagram of a pixel of the display device, according to the exemplary embodiment.

FIG. 3 is a top plan view partially illustrating the display device, according to the exemplary embodiment.

FIG. 4 is a cross-sectional view of the display device taken along the line IV-IV of FIG. 3.

FIG. 5 is a cross-sectional view of the display device taken along the line V-V of FIG. 3.

FIG. 6 is a cross-sectional view of the display device taken along the line VI-VI of FIG. 3.

FIG. 7 to FIG. 25 are process cross-sectional views of a manufacturing method of a display device, according to an exemplary embodiment.

### DETAILED DESCRIPTION

The present disclosure will be described more fully hereinafter with reference to the accompanying drawings, in which exemplary embodiments of the present disclosure are shown. As those skilled in the art would realize, the described embodiments may be modified in various different ways, without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or one or more intervening elements may also be present. In contrast, when an element is referred to as being “directly on” another element, there may be no intervening elements present.

Hereinafter, a display device according to an exemplary embodiment will be schematically described with reference to the accompanying drawings.

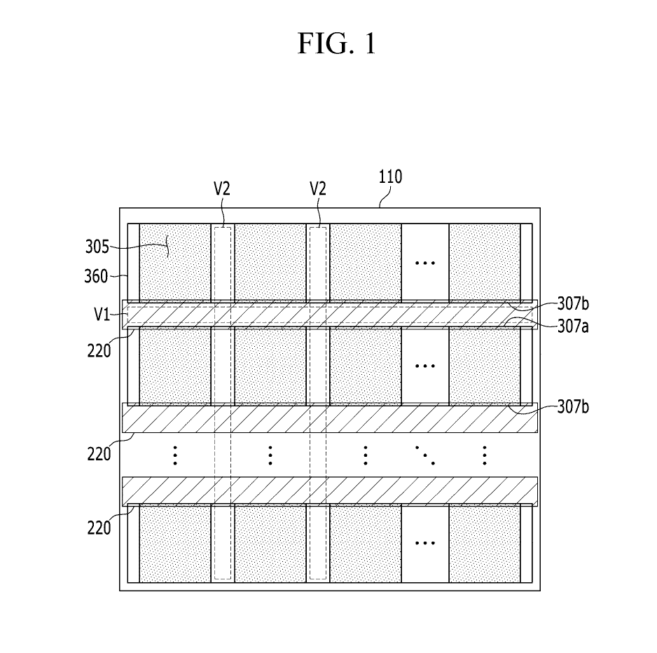

FIG. 1 is a top plan view of a display device, according to an exemplary embodiment. The display device includes a substrate 110 made of a material such as glass, plastic, and the like.

A plurality of microcavities 305 are provided on the substrate 110 and covered by a roof layer 360. A plurality of microcavities 305 are provided below a single roof layer 360 that extends in a row direction.

The microcavities 305 may be arranged in a matrix format. A first region V1 may be provided between microcavities 305 that neighbor each other along a column direction and a second region V2 may be provided between microcavities 305 that neighbor each other along the row direction.

The first region V1 is provided between a plurality of roof layers 360. The microcavity 305 in an area that overlaps the first region V1 may be exposed to the outside rather than being covered by the roof layer 360. The exposed portions serve as injection holes 307a and 307b.

The injection holes 307a and 307b are provided at lateral edges of the microcavities 305. The injection holes 307a and 307b include a first injection hole 307a and a second injection hole 307b. The first injection hole 307a exposes a side surface of a first edge of the microcavity 305, and the second injection hole 307b exposes a side surface of a second edge of the microcavity 305. The side surface of the first edge and the side surface of the second edge of the microcavity 305 may face each other.

The respective roof layers 360 are distanced from the substrate 110 between neighboring second regions V2 such that the microcavities 305 are formed in the empty spaces. That is, the roof layers 360 cover other side surfaces of the microcavities 305, except for the side surfaces of the first and second edges where the injection holes 307a and 307b are formed.

A light blocking member 220 is provided in the first region V1. A thin film transistor and the like are formed in the first region V1. The light blocking member 220 overlaps the thin film transistor and the like such that light leakage can be reduced or prevented. The light blocking member 220 may be entirely provided in the first region V1, and partially overlap an edge of the microcavity 305 that is adjacent to the first region V1. Thus, the light blocking member 220 may overlap the injection holes 307a and 307b.

It is illustrated in FIG. 1 that the light blocking member 220 is provided only in the first region V1 but is not provided in the second region V2. However, the present disclosure is not limited thereto, and the light blocking member 220 may be provided in the second region V2.

The above-described structure of the display device according to the exemplary embodiment is only an example, and may be variously modified. As an example, the layout of the first region V1 and the second region V2 in the microcavities 305 can be modified, the plurality of roof layers 360 may be connected to each other in the first region V1, and a part of each roof layer 360 may be distanced from the substrate 110 in the second region V2 such that neighboring microcavities 305 may be connected to each other.

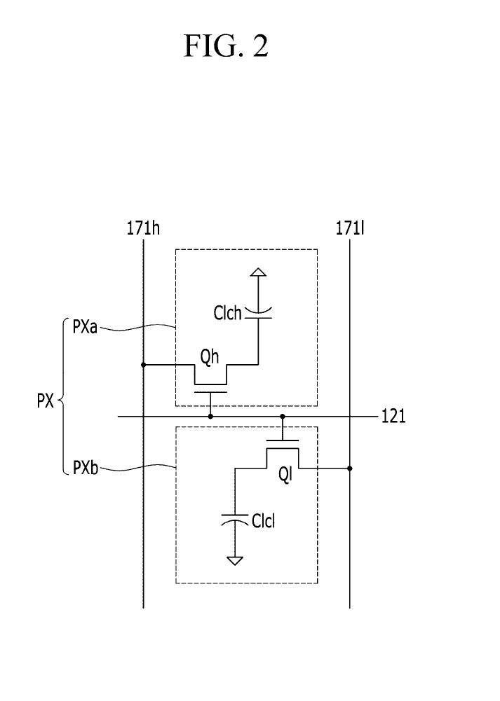

Hereinafter, a pixel of the display device according to the exemplary embodiment will be described with reference to FIG. 2.

FIG. 2 is an equivalent circuit diagram of a pixel of the display device, according to the exemplary embodiment. The display device includes a plurality of signal lines 121, 171h, and 171l, and pixels PX connected to the signal lines. Although it is not illustrated, the plurality of pixels PX may include a plurality of pixel rows and columns and arranged in a matrix format.

Each pixel PX may include a first subpixel PXa and a second subpixel PXb. The first subpixel PXa and the second subpixel PXb may be vertically arranged. In this case, the first region V1 may be disposed along the row direction between the first subpixel PXa and the second subpixel PXb, and the second region V2 may be disposed between a plurality of pixel columns.

The signal lines 121, 171h, and 171l include a gate line 121 that transmits a gate line, and a first data line 171h and a second data line 171l that transmits different data voltages. A first thin film transistor Qh is connected with the gate line 121 and the first data line 171h, and a second thin film transistor Ql is connected with the gate line 121 and the second data line 171l. A first liquid crystal capacitor Clch connected with the first thin film transistor Qh is provided in the first subpixel PXa, and a second liquid crystal capacitor Clcl connected with the second thin film transistor Ql is provided in the second subpixel PXb.

A first terminal of the first thin film transistor Qh is connected to the gate line 121, a second terminal is connected to the data line 171h, and a third terminal is connected to the first liquid crystal capacitor Clch. A first terminal of the second thin film transistor Ql is connected to the gate line 121, a second terminal is connected to the second data line 171l, and a third terminal is connected to the second liquid crystal capacitor Clcl.

When a gate-on voltage is applied to the gate line 121, the first thin film transistor Qh and the second thin film transistor Ql that are connected to the gate line 121 enter a turn-on state. The first and second liquid crystal capacitors Clch and Clcl are respectively charged by different data voltages transmitted through the first data line 171h and the second data line 171l, respectively. The data voltage transmitted through the second data line 171l is lower than the data voltage transmitted through the first data line 171h. Thus, the second liquid crystal capacitor Clcl is charged with a lower voltage than the first liquid crystal capacitor Clch, thereby improving side visibility.

However, the present disclosure is not limited thereto, and the layout of the thin film transistors can be variously modified for an application of different voltages to the two subpixels PXa and PXb. A pixel PX may include two or more subpixels, or may be formed of a single pixel.

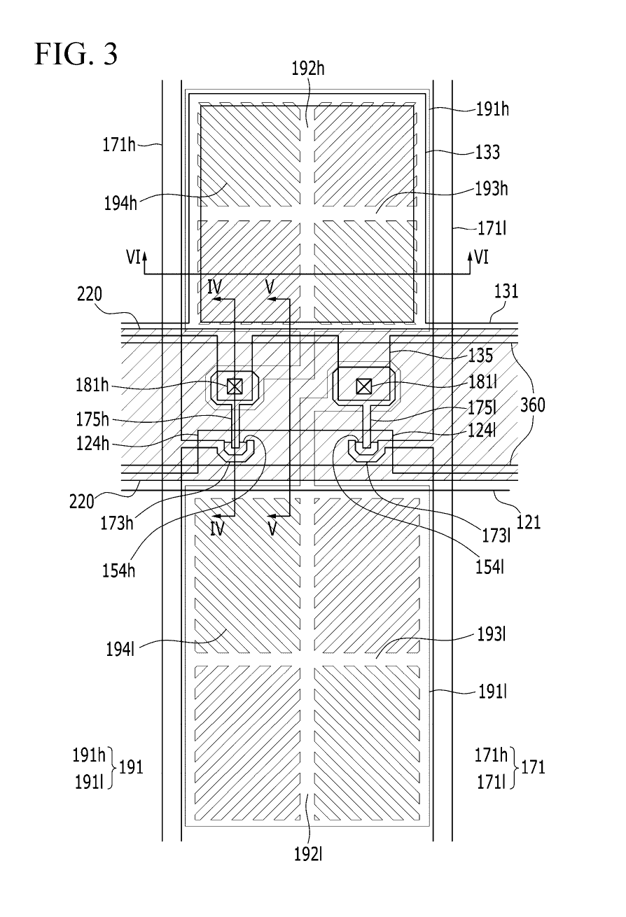

Hereinafter, a structure of a pixel of the display device according to the exemplary embodiment will be described with reference to FIG. 3 to FIG. 6.

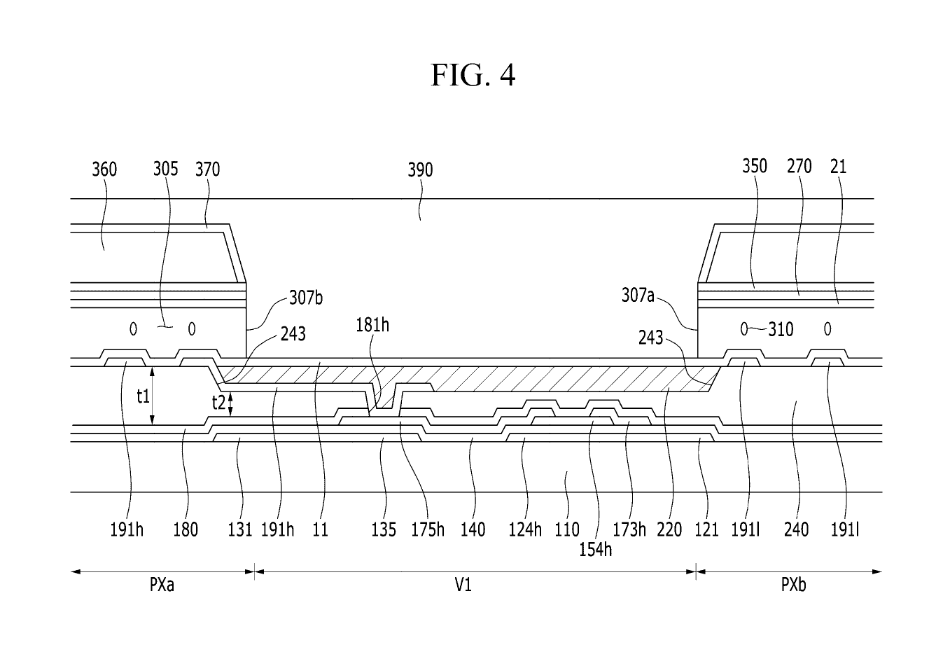

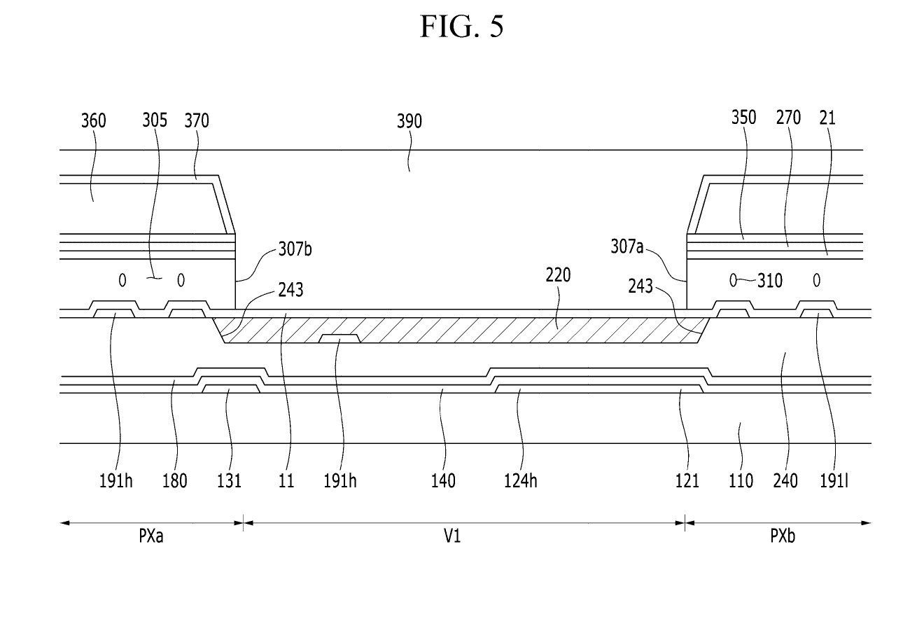

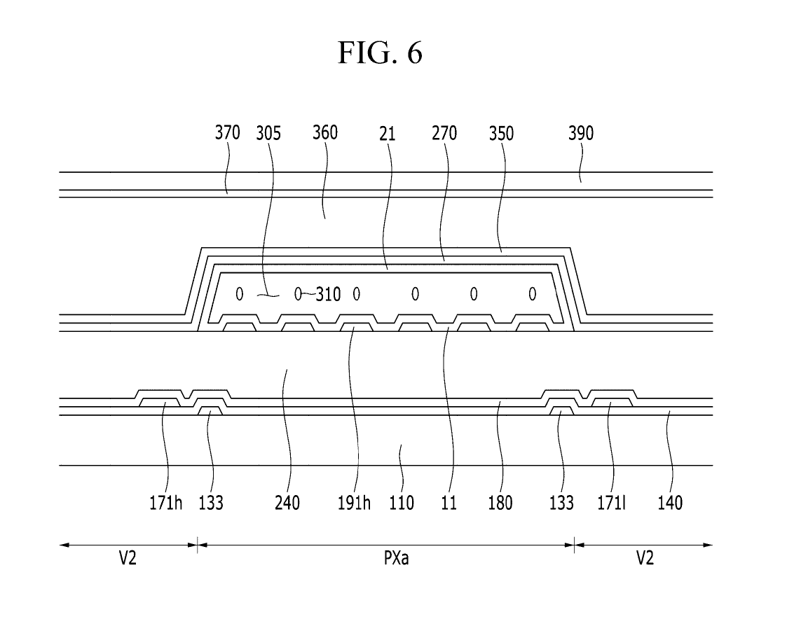

FIG. 3 is a top plan view that partially illustrates the display device, according to the exemplary embodiment. FIG. 4 is a cross-sectional view of the display device taken along the line IV-IV of FIG. 3, FIG. 5 is a cross-sectional view of the display device taken along the line V-V of FIG. 3, and FIG. 6 is a cross-sectional view of the display device taken along the line VI-VI of FIG. 3.

Referring to FIG. 3 to FIG. 6, a gate metal layer including a first gate electrode 124h and a second gate electrode 124l is provided on the substrate 110. The first gate electrode 124h and the second gate electrode 124l are protruded from the gate line 121.

The gate line 121 extends in a first direction and transmits a gate signal. The gate line 121 is disposed in the first region V1 between two microcavities 305 that are adjacent to each other along a column direction. In the top plan view, the first gate electrode 124h and the second gate electrode 124l protrude upward at an upper side of the gate line 121. The first gate electrode 124h and the second gate electrode 124l may be connected with each other and form a single protrusion. However, the present disclosure is not limited thereto, and the protruding form of the first and second gate electrodes 124h and 124l can be variously modified.

A reference voltage line 131 and storage electrodes 133 and 135 protruded from the reference voltage line 131 are provided in the substrate 110. The reference voltage line 131 extends in parallel with the gate line 121, while being separated from the gate line 121. A constant voltage may be applied to the reference voltage line 131. The storage electrode 133 protruding above the reference voltage line 131 surrounds the edge of the first subpixel PXa. The storage electrode 135 protruded below the reference voltage line 131 is adjacent to the first gate electrode 124h and the second gate electrode 124l. The storage electrode 135 protruded below the reference voltage line 131 overlaps a first drain electrode 175h and a second drain electrode 175l.

A gate insulating layer 140 is provided on the gate line 121, the first gate electrode 124h, the second gate electrode 124l, the reference voltage line 131, and the storage electrodes 133 and 135. The gate insulating layer 140 may be made of an inorganic insulating material such as a silicon nitride (SiNx), a silicon oxide (SiOx), and the like. Further, the gate insulating layer 140 may be formed as a single layer or a multilayer.

A first semiconductor 154h and a second semiconductor 154l are provided on the gate insulating layer 140. The first semiconductor 154h may overlap the first gate electrode 124h, and the second semiconductor 154l may overlap the second gate electrode 124l. The first semiconductor 154h may be provided below the first data line 171h, and the second semiconductor 154l may be provided below the second data line 171l. The first semiconductor 154h and the second semiconductor 154l may be made of amorphous silicon, polycrystalline silicon, a metal oxide, and the like.

Ohmic contact members (not shown) may be provided respectively above the first semiconductor 154h and the second semiconductor 154l. The ohmic contact members may be made of a silicide or a material such as n+ hydrogenated amorphous silicon in which an n-type impurity is doped at a high concentration.

A data metal layer including the first data line 171h, the second data line 171l, a first source electrode 173h, the first drain electrode 175h, a second source electrode 173l, and the second drain electrode 175l is provided above the first semiconductor 154h, the second semiconductor 154l, and the gate insulating layer 140.

The first data line 171h and the second data line 171l transmit data signals and extend in a second direction to cross the gate line 121 and the reference voltage line 131. The second direction may be perpendicular to the first direction in which the gate line 121 extends. The data line 171 is disposed in the second region V2 between two microcavities 305 that neighbor each other in the row direction. The first data line 171h and the second data line 171l transmit data signals that are different from each other. For example, a data voltage transmitted through the second data line 171l may be lower than a data voltage transmitted through the first data line 171h.

The first source electrode 173h protrudes above the first gate electrode 124h from the first data line 171h, and the second source electrode 173l protrudes above the second gate electrode 124l from the second data line 171l. Each of the first drain electrode 175h and the second drain electrode 175l includes a wide end and a bar-shaped end. The wide ends of the first and second drain electrodes 175h and 175l respectively overlap the storage electrode 135 that is protruded below the reference voltage line 131. The bar-shaped ends of the first and second drain electrodes 175h and 175l are partially surrounded by the first source electrode 173h and the second source electrode 173l, respectively.

The first gate electrode 124h, the first source electrode 173h, and the first drain electrode 175h form the first thin film transistor Qh together with the first semiconductor 154h. In addition, the second gate electrode 124l, the second source electrode 173l, and the second drain electrode 175l form the second thin film transistor Ql together with the first semiconductor 154l. A channel of the first thin film transistor Qh is formed in the first semiconductor 154h between the first source electrode 173h and the first drain electrode 175h. In addition, a channel of the second thin film transistor Ql is formed in the second semiconductor 154l between the second source electrode 173l and the second drain electrode 175l.

A passivation layer 180 is provided above the first semiconductor 154h between the first source electrode 173h and the first drain electrode 175h. In addition, the passivation layer 180 is provided above the second semiconductor 154l between the second source electrode 173l and the second drain electrode 175l. The passivation layer 180 may be made of an inorganic insulating material.

A first insulating layer 240 is provided above the passivation layer 180. The first insulating layer 240 is made of an organic insulating material.

A trench 243 is formed in the first insulating layer 240 between edges of the first subpixel PXa and the second subpixel PXb. A boundary of the trench 243 may match the boundary of the first area V1 or may be disposed inside or outside the first area V1.

The first insulating layer 240 is made of an organic material, and the upper surface of the first insulating layer 240 is flat where the trench 243 is formed. The height of the first insulating layer 240 where the trench 243 is formed is lower than the height of the other portion of the first insulating layer 240. That is, the height of the bottom surface of the trench 243 is lower than the height of a portion of the first insulating layer 240 that overlaps the microcavity 305. Further, a thickness t2 of a portion of the first insulating layer 240, where the trench 243 is formed, is thinner than a thickness t1 of a portion of the first insulating layer 240, where the trench 243 is not formed. In one embodiment, a ratio of the thickness t2 compared to the thickness t1 is about 20% or more and about 90% or less. Further, the portion where the trench 243 is formed in the first insulating layer 240 and the portion where the trench 243 is not formed in the first insulating layer 240 may have a step of between about 0.5 μm or more and about 5 μm or less. That is, the depth of the trench 243 may be about 0.5 μm or more and about 5 μm or less.

For example, when the thickness t1 is about 5 μm, the thickness t2 may be from about 1 μm or more to about 4.5 μm or less. Further, when the thickness t1 is about 1 μm, the thickness t2 may be from about 0.5 μm or more to about 0.9 μm or less.

When a ratio (t2/t1) of the thickness t2 to the thickness t2 is less than about 20%, the depth of the trench 243 becomes shallow. The shallowness of the trench 243 affects the thickness of the light blocking member 220. When the depth of the trench 243 is shallow, the thickness of the light blocking member 220 becomes thin, thereby deteriorating the light blocking efficiency. In one embodiment, the ratio (t2/t1) of the thickness t2 to the thickness t1 is about 20% or more, and the depth of the trench 243 is about 0.5 μm or more.

Further, when the ratio (t2/t1) of the thickness t2 to the thickness t1 is about 90% or more, the depth of the trench 243 becomes deep. Accordingly, an electrical effect between a pixel electrode 191 and a gate metal layer or a data metal layer that are provided below the first insulating layer 240 may be increased. In addition, the pixel electrode 191 is connected to a portion of the first insulating layer 240 where the trench 243 is not formed, through a side surface of the trench 243 from the inside of the trench 243. When the depth of the trench 243 becomes too deep, the pixel electrode 191 may be short-circuited. To prevent the pixel electrode 191 from being short-circuited, the ratio (t2/t1) of the thickness t1 to the thickness t2 may be chosen to be about 90% or less, and the depth of the trench 243 may be chosen to be about 5 μm or less.

The first insulating layer 240 is formed of a single organic insulating material, but the present disclosure is not limited thereto. In some embodiments, the first insulating layer 240 may be formed of a plurality of color filters.

Each color filter may display one of primary colors such as three primary colors of red, green, and blue, but this is not restrictive. The color filter may display one or cyan, magenta, yellow, a white-based color, and the like. A different color filter may be disposed in each pixel column, and color filters that neighbor in the second region V2 may overlap each other. When two different color filters overlap, light leakage in the second region V2 can be prevented.

The first insulating layer 240 is made of an organic insulating material in the present exemplary embodiment, but the present disclosure is not limited thereto. The first insulating layer 240 may be formed as a multiple layer formed by layering an organic insulating material and an inorganic insulating material.

A first contact hole 181h exposing the wide end of the first drain electrode 175h and a second contact hole 181l exposing the wide end of the second drain electrode 171l are provided in the passivation layer 180 and the first insulating layer 240. The pixel electrode 191 is provided above the first insulating layer 240. The pixel electrode 191 may be made of a transparent metal oxide such as indium tin oxide (ITO), indium zinc oxide (IZO), and the like.

The pixel electrode 191 may include a first subpixel electrode 191h and a second subpixel electrode 191l that are separated from each other. The first subpixel electrode 191h and second subpixel electrode 191l are respectively disposed above and below the gate line 121 and the reference voltage 131 on a plane. That is, the first subpixel electrode 191h and the second subpixel electrode 191l are separated from each other while interposing the first region V1 therebetween. The first subpixel electrode 191h is disposed in the first subpixel PXa, and the second subpixel electrode 191l is disposed in the second subpixel PXb.

The first subpixel electrode 191h is connected with the first drain electrode 175h through the first contact hole 181h, and the second subpixel electrode 191l is connected with the second drain electrode 175l through the second contact hole 181l. Thus, when the first thin film transistor Qh and the second thin film transistor Q1 are in the turn-on state, the first subpixel electrode 191h and the second subpixel electrode 191l respectively receive different data voltages from the first drain electrode 175h and the second drain electrode 175l.

The shape of each of the first and second subpixel electrodes 191h and 191l is a quadrangle. The first and second subpixel electrodes 191h and 191l respectively include a cross stem configured by horizontal stems 193h and 193l and vertical stems 192h and 192l orthogonally crossing the horizontal stems 193h and 193l. Further, the first subpixel electrode 191h and the second subpixel electrode 191l respectively include a plurality of minute branches 194h and 194l.

The pixel electrode 191 is divided into four subregions by the horizontal stems 193h and 193l and the vertical stems 192h and 192l. The minute branches 194h and 194l obliquely extend from the horizontal stems 193h and 193l and the vertical stems 192h and 192l, and the extension direction of the minute branches 194h and 194l may form an angle of about 45 degrees or about 135 degrees with the gate line 121 or the horizontal stems 193h and 193l. Further, the minute branches 194h and 194l in two neighboring subregions may extend in directions that perpendicularly cross each other. In the present exemplary embodiment, the first subpixel electrode 191h and the second subpixel electrode 191l may further include stem portions that surround outer edges of the first and second subpixels PXa and PXb.

The layout form of the pixel, the structure of the thin film transistor, and the shape of the pixel electrode described above are just exemplified, and the present disclosure is not limited thereto and may be variously modified.

The light blocking member 220 is provided in the trench 243. The light blocking member 220 is provided above the first insulating layer 240 and the pixel electrode 191. The light blocking member 220 is disposed in the first region V1 and overlaps the first thin film transistor Qh and the second thin film transistor Ql. The light blocking member 220 prevents light leakage in the first region V1. The light blocking member 220 may be provided in the entire area of the first region V1 and may overlap a partial edge of the first and second subpixels PXa and PXb.

The light blocking member 220 fills the trench 243, and may not be provided outside of the trench 243. The upper surface of the first insulating layer 240 and the upper surface of the light blocking member 220 may be substantially flat. The height of the upper surface of the light blocking member 220 may be lower than or substantially equal to the height of the upper surface of a portion of the first insulating layer 240 where the trench 243 is not provided. That is, the height of the upper surface of the light blocking member 220 is lower than or equal to the height of the upper surface of a portion of the first insulating layer 240 that overlaps the microcavity 305. The height of the upper surface of the light blocking member 220 may be defined as a distance between the upper surface of the substrate 110 and the upper surface of the light blocking member 220. In addition, the height of the first insulating layer 240 may be defined as a distance between the upper surface of the substrate 110 and the upper surface of the first insulating layer 240.

The light blocking member 220 may be formed of a photoresist. The photoresist includes a positive photoresist and a negative photoresist. The light blocking member 220 may be patterned through a photo-process. In one embodiment, the light blocking member 220 may be patterned only through a developing process without performing an exposure process. In this case, the light blocking member 220 is formed of a negative photoresist.

A common electrode 270 is provided above the pixel electrode 191 at a distance from the pixel electrode 191. The microcavity 305 is provided between the pixel electrode 191 and the common electrode 270. That is, the microcavity 305 is surrounded by the pixel electrode 191 and the common electrode 270. The common electrode 270 extends in the row direction, and is provided above the microcavity 305 and in the second region V2. The common electrode 270 covers the upper surface and a part of the side surface of the microcavity 305. The size of the microcavity 305 may be variously modified according to the side and resolution of the display device.

However, the present disclosure is not limited thereto, and the common electrode 270 may be provided at a distance from the pixel electrode 191, interposing an insulating layer therebetween. In this case, the microcavity 305 may be provided above the common electrode 270.

The common electrode 270 may be made of a transparent metal oxide such as indium tin oxide (ITO), indium zinc oxide (IZO), and the like. The common electrode 270 may receive a constant voltage, and an electric field corresponding to the received constant voltage may be formed between the pixel electrode 191 and the common electrode 270.

Alignment layers 11 and 21 are provided above the pixel electrode 191 and below the common electrode 270. The alignment layers 11 and 21 include a first alignment layer 11 and a second alignment layer 21. The first alignment layer 11 and the second alignment layer 21 may be provided as vertical alignment layers, and may be made of an alignment material such as polyamic acid, polysiloxane, polyimide, and the like. However, the present disclosure is not limited thereto, and the first alignment layer 11 and the second alignment layer 21 may be provided as horizontal alignment layers. The first and second alignment layers 11 and 21 may be connected to each other at a side wall at the edge of the microcavity 305.

The first alignment layer 11 is provided above the pixel electrode 191 and the first insulating layer 240 that is not covered by the pixel electrode 191. Further, the first alignment layer 11 may be provided in the first region V1. In this case, the first alignment layer 11 is provided above the light blocking member 220. The second alignment layer 21 is provided below the common electrode 270 and faces the first alignment layer 11.

A liquid crystal layer formed of liquid crystal molecules 310 is provided in the microcavity 305 that is disposed between the pixel electrode 191 and the common electrode 270. The liquid crystal molecules 310 may have negative dielectric anisotropy and stand up in a direction perpendicular to the substrate 110 while no electric field is applied. In this case, the liquid crystal molecules 310 may be vertically aligned. However, the present disclosure is not limited thereto, and the liquid crystal molecules 310 may be horizontally aligned.

The first subpixel electrode 191h and the second subpixel electrode 191l generate an electric field based on the applied data voltages to determine an alignment direction of the liquid crystal molecules 310 in the microcavity 305 that is disposed between the pixel electrode 191 and the common electrode 270. The direction of the liquid crystal molecules 310 affects luminance of light passing through the liquid crystal layer.

A second insulating layer 350 may be provided above the common electrode 270. The second insulating layer 350 may be made of an inorganic insulating material such as a silicon nitride (SiNx), a silicon oxide (SiOx), and the like. The second insulating layer 350 may be omitted in some embodiments.

The roof layer 360 is provided above the second insulating layer 350. The roof layer 360 may be made of an organic material. The roof layer 360 is provided in a row direction, and is disposed above the microcavity 305 and in the second region V2. The roof layer 360 covers the upper surface and a part of the side surface of the microcavity 305. The roof layer 360 becomes rigid through a curing process to maintain the shape of the microcavity 305. The microcavity 305 is interposed between the pixel electrode 191 and the roof layer 360.

The roof layer 360 is made of a single organic insulating material, but the present disclosure is not limited thereto. In some embodiments, the roof layer 360 may be configured by a plurality of color filters instead of the first insulating layer 240 being configured by color filters.

The common electrode 270 and the roof layer 360 do not cover a part of the side surface of the edge of the microcavity 305. The portions of the microcavity 305 that are not covered by the common electrode 270 and the roof layer 360 are referred to as injection holes 307a and 307b. The injection holes 307a and 307b include the first injection hole 307a exposing a side surface of the first edge of the microcavity 305 and the second injection hole 307b exposing a side surface of the second edge of the microcavity 305. The first edge and the second edge face each other. For example, the first edge may be the upper edge side of the microcavity 305, and the second edge may be the bottom edge side of the microcavity 305. The microcavity 305 is exposed through the injection holes 307a and 307b during a manufacturing process, and an alignment solution or a liquid crystal material can be injected into the microcavity 305 through the injection holes 307a and 307b.

For comparison with the present disclosure, a structure in which the trench 243 is not provided in the first insulating layer 240 and the light blocking member 220 is provided above the first insulating layer 240 is considered. In such a structure, when the thickness of the light blocking member 220 is increased, the size of injection holes 307a and 307b is reduced due to the increased thickness of the light blocking member 220. Accordingly, the injection holes 307a and 307b may be blocked during an injection process of an alignment solution or a liquid crystal material preventing the alignment solution or the liquid crystal material from being easily injected into the microcavity 305. Conversely, when the thickness of the light blocking member 220 is reduced, the injection holes 307a and 307b can be prevented from being blocked, but the light blocking efficiency is reduced.

In the present exemplary embodiment, the trench 243 is provided in the first insulating layer 240, and the light blocking member 220 is provided in the trench 243. The first insulating layer 240 and the light blocking member 220 have flat upper surfaces. The thickness of the light blocking member 220 can be appropriately adjusted for prevention of light leakage by adjusting the depth of the trench 243. Further, injection of the alignment solution or the liquid crystal material can be easily performed without reducing the size of the injections hole 307a and 307b due to the thickness of the light blocking member 220.

A third insulating layer 370 may be provided above the roof layer 360. The third insulating layer 370 may be made of an inorganic insulating material such as a silicon nitride (SiNx), a silicon oxide (SiOx), and the like. The third insulating layer 370 may cover the upper surface and/or a side surface of the roof layer 360. The third insulating layer 370 protects the roof layer 360 that is made of an organic material. In some embodiments, the third insulating layer 370 may be omitted.

An encapsulation layer 390 is provided above the third insulating layer 370. The encapsulation layer 390 covers the injection holes 307a and 307b that partially expose the microcavity 305 to the outside. The encapsulation layer 390 seals the microcavity 305 to prevent the leakage of the liquid crystal material formed inside the microcavity 305 to the outside. The encapsulation layer 390 may be made of a material that does not react with the liquid crystal molecules 310 because the encapsulation layer 390 contacts the liquid crystal molecules 310. For example, the encapsulation layer 390 may be made of parylene.

The encapsulation layer 390 may be provided as a multilayer, for example, a double layer or a triple layer. The double layer is configured by two layers made of different materials. The triple layer is configured by three layers, and materials of adjacent layers are different from each other. For example, the capping layer 390 may include a first layer made of an organic insulating material and a second layer made of an inorganic insulating material.

Although not illustrated, polarizers may be formed on upper and lower surfaces of the display device. The polarizers may include a first polarizer and a second polarizer. The first polarizer may be attached to the lower surface of the substrate 110, and the second polarizer may be attached to the encapsulation layer 390.

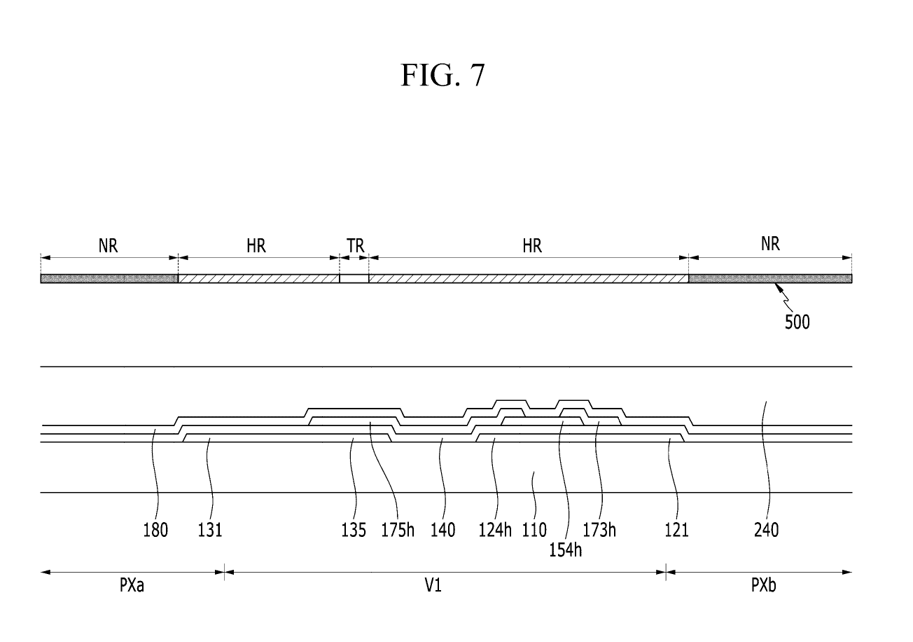

Next, referring to FIG. 7 to FIG. 25, a method for manufacturing a display device according to an exemplary embodiment will be described. In the following description, FIG. 1 to FIG. 6 will be referred as well.

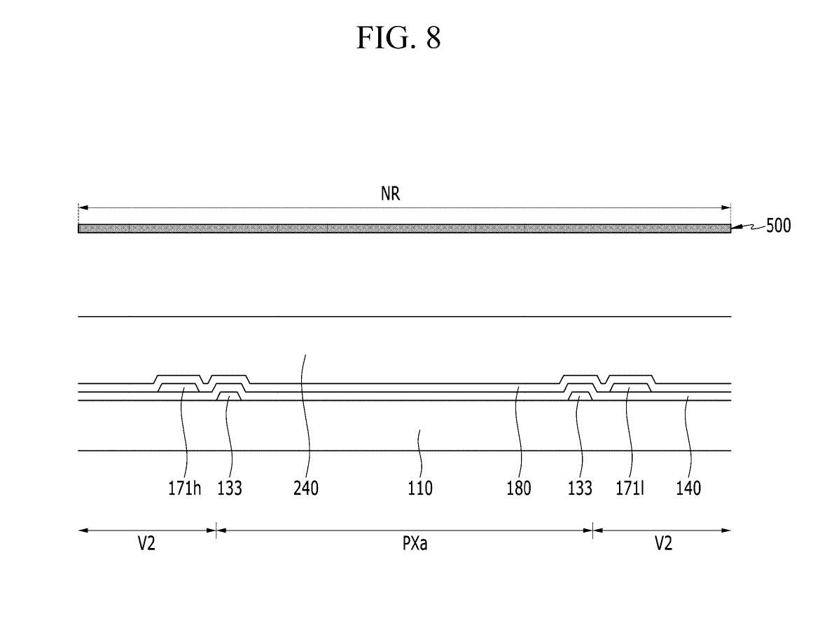

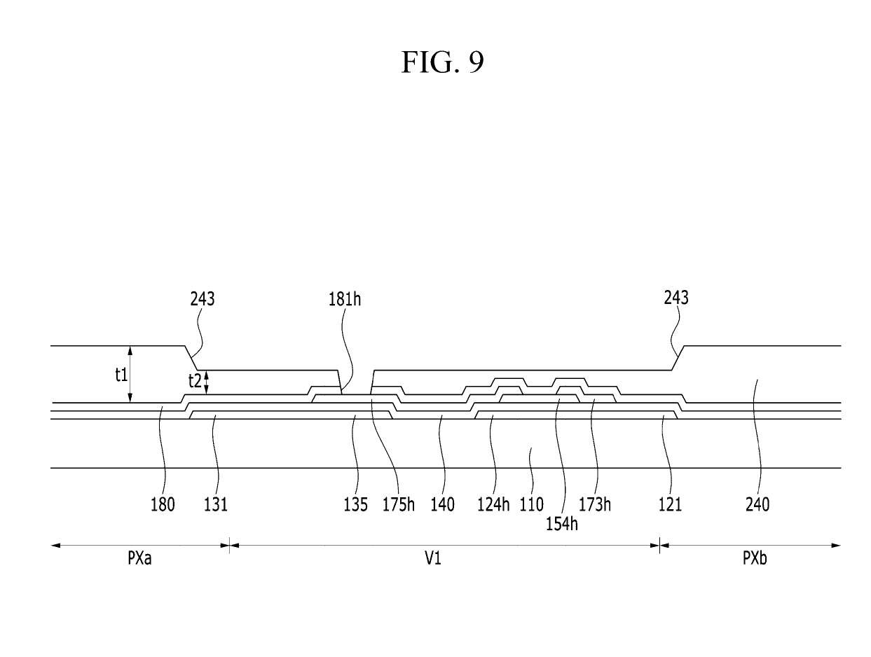

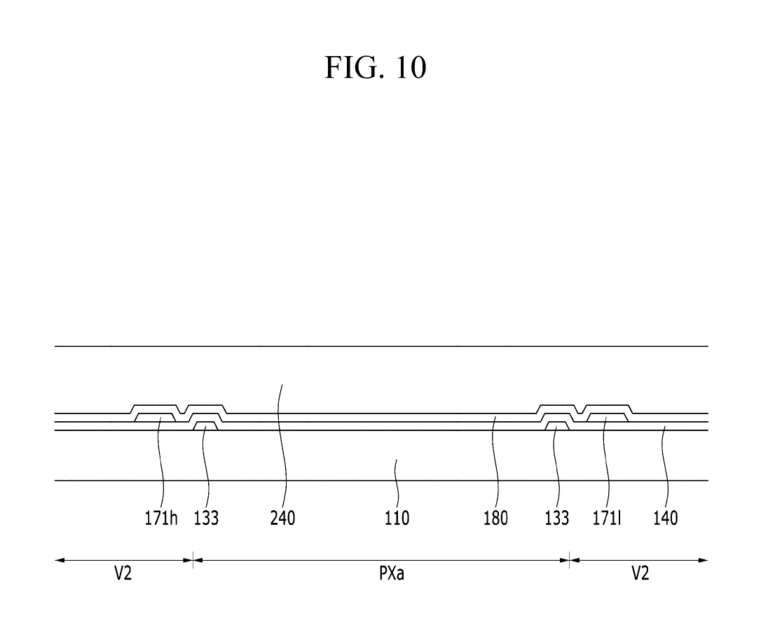

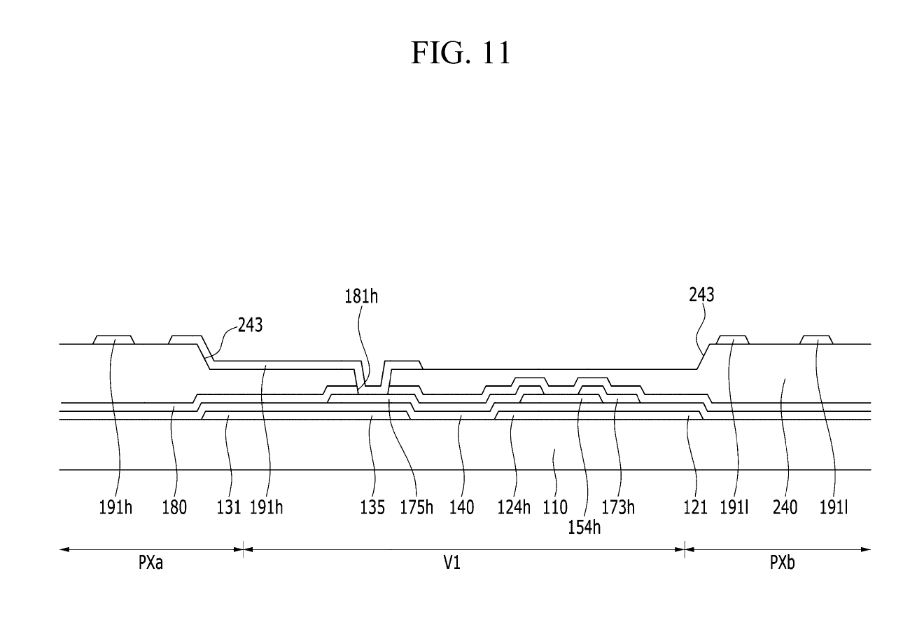

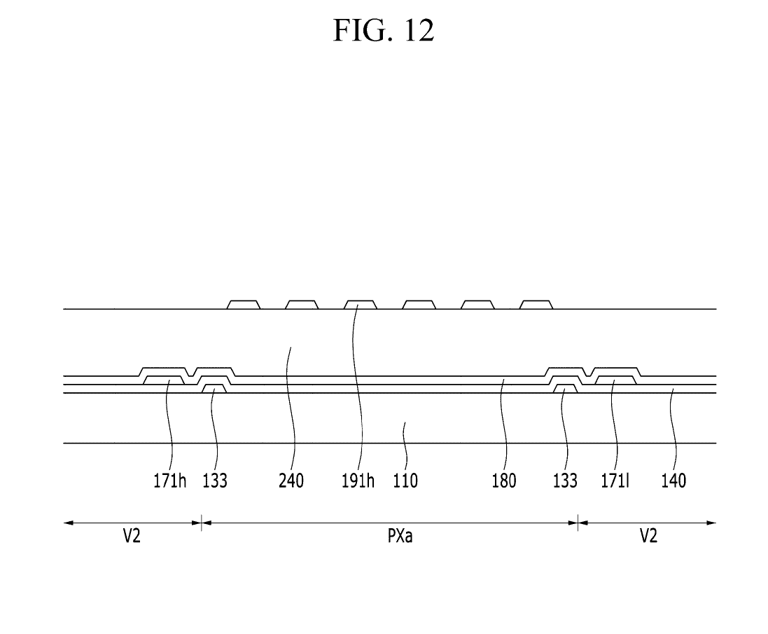

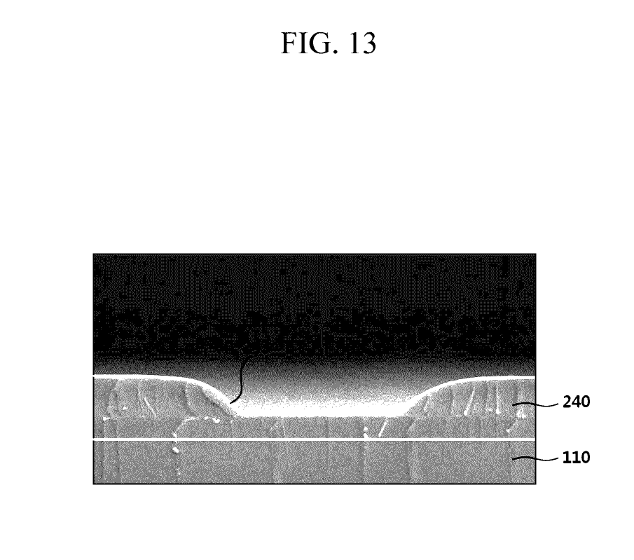

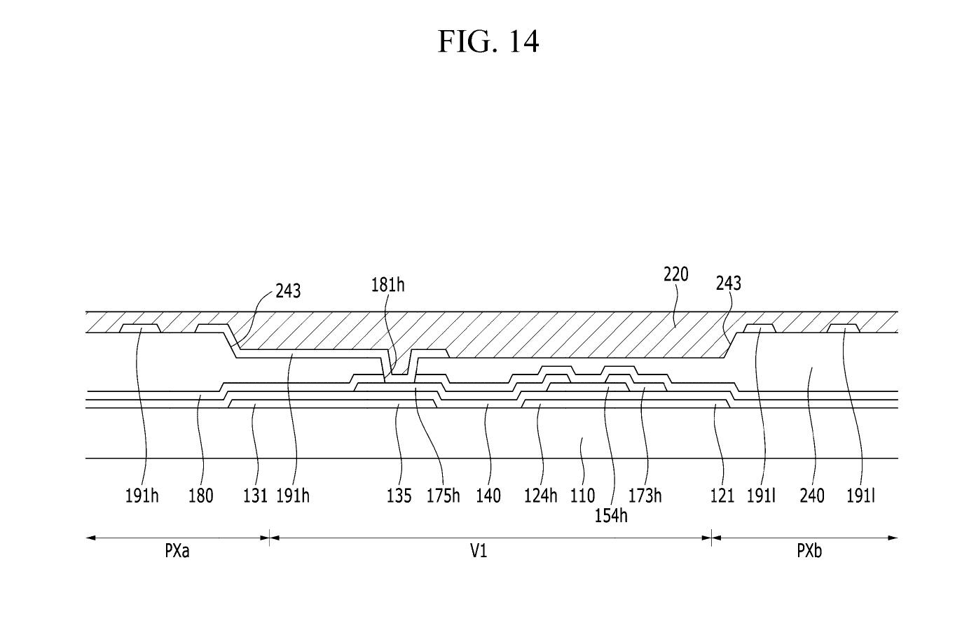

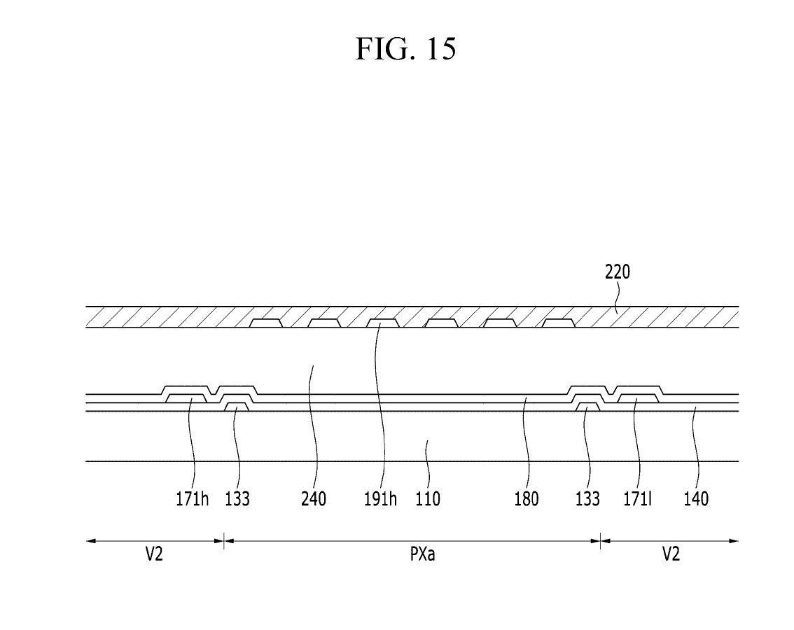

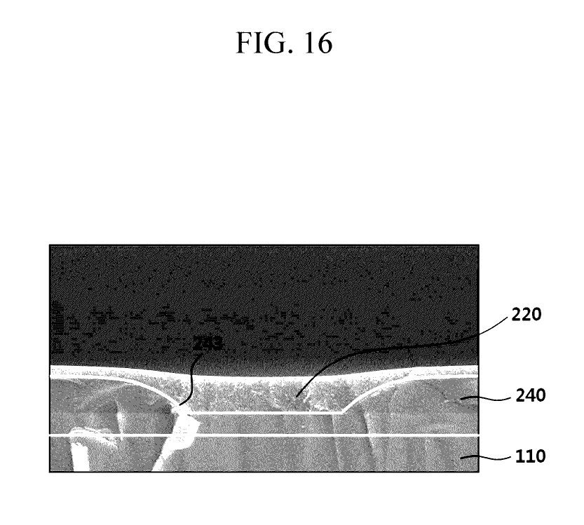

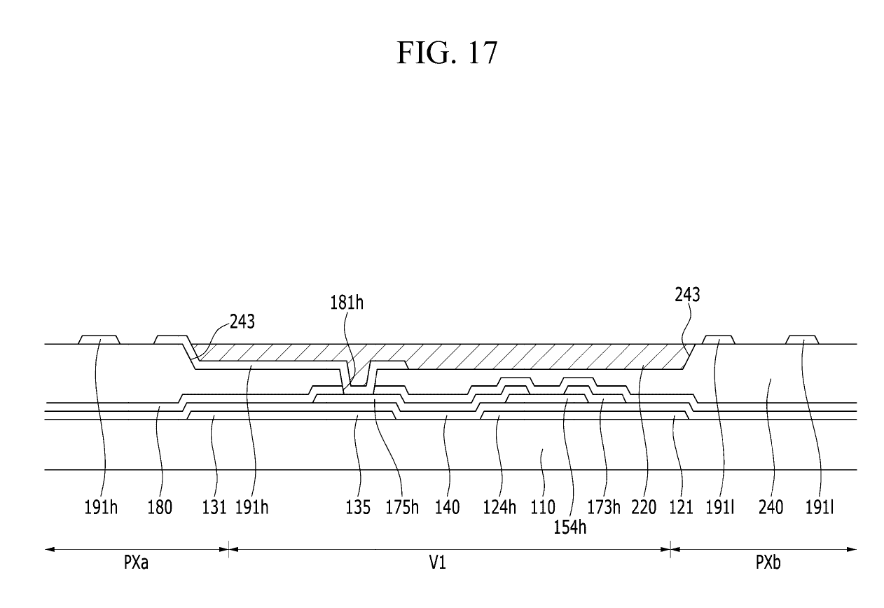

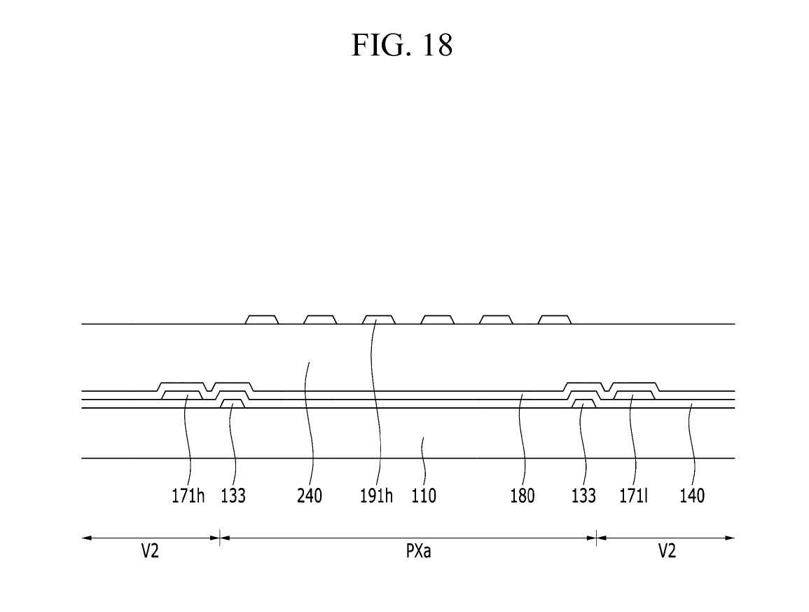

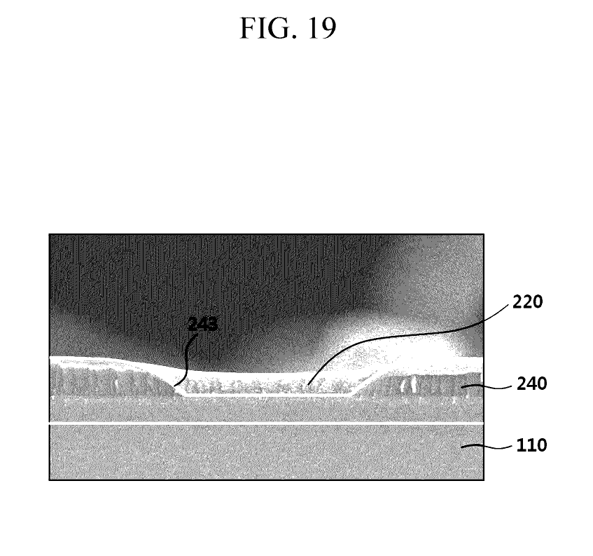

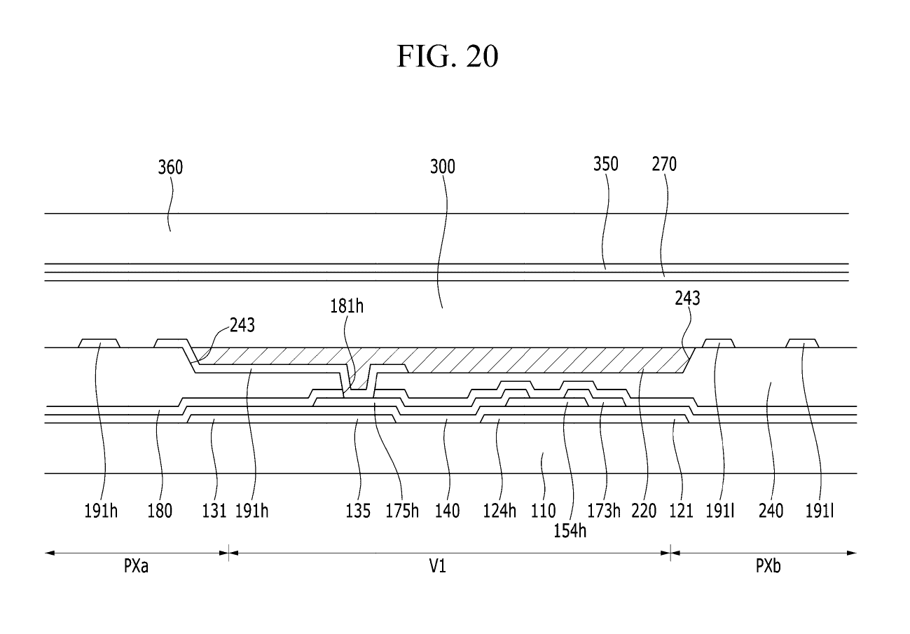

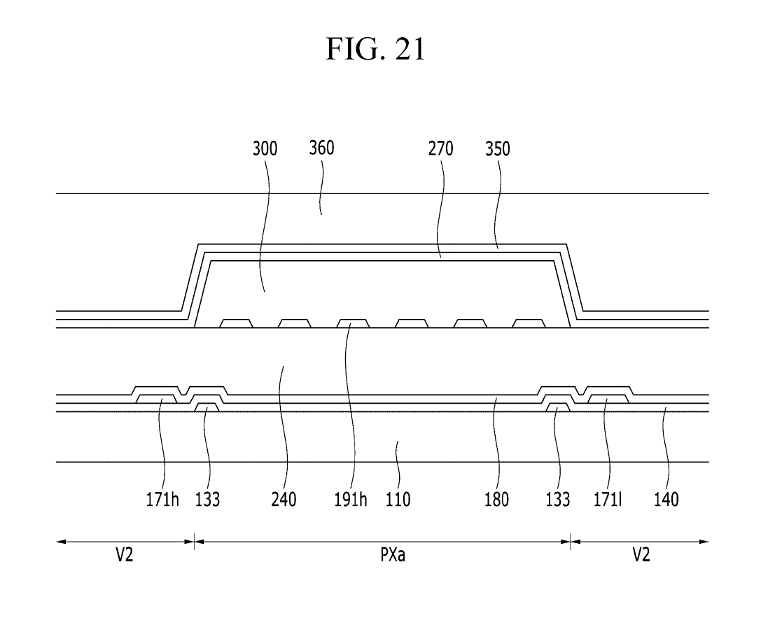

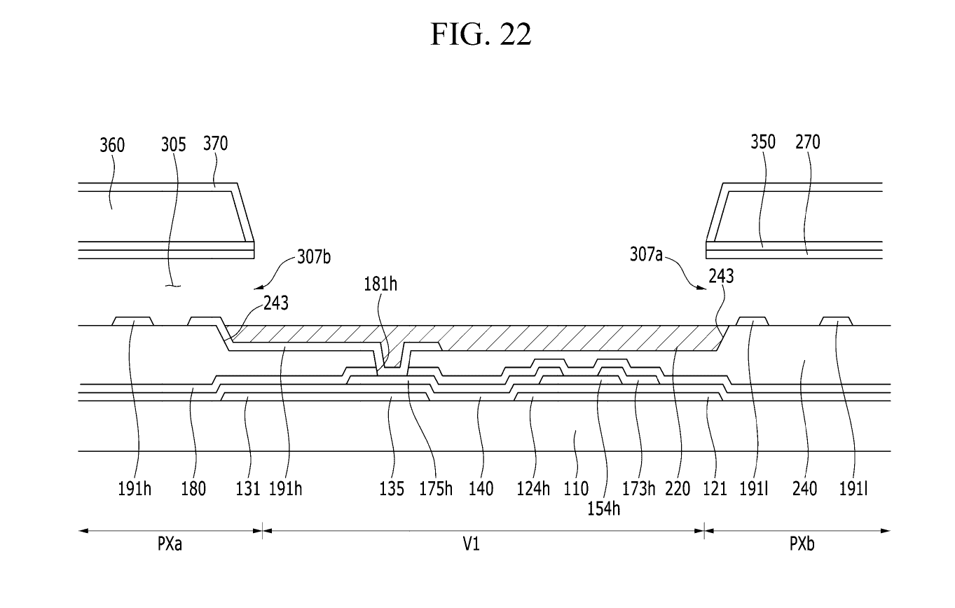

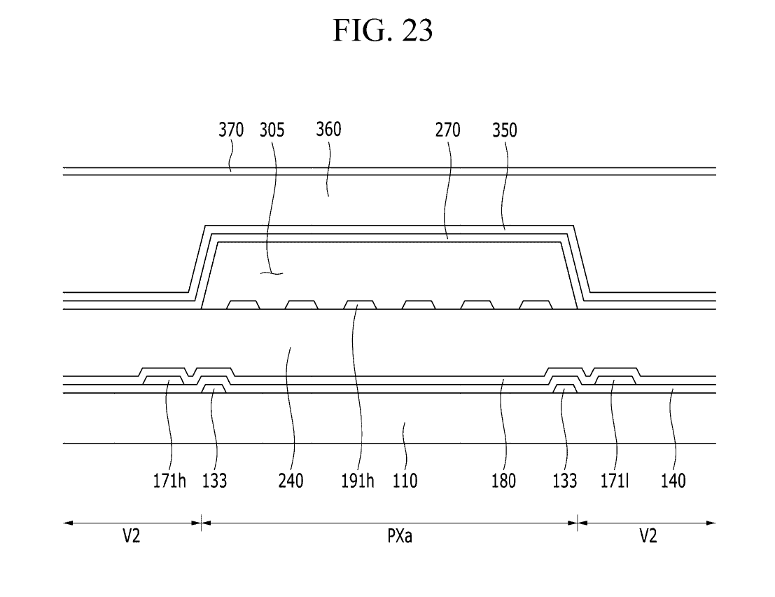

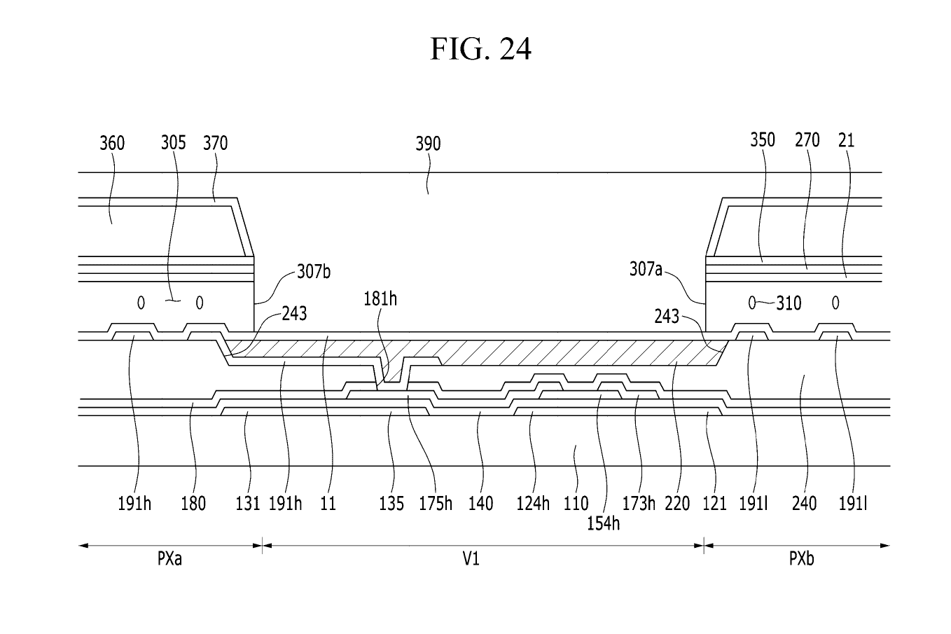

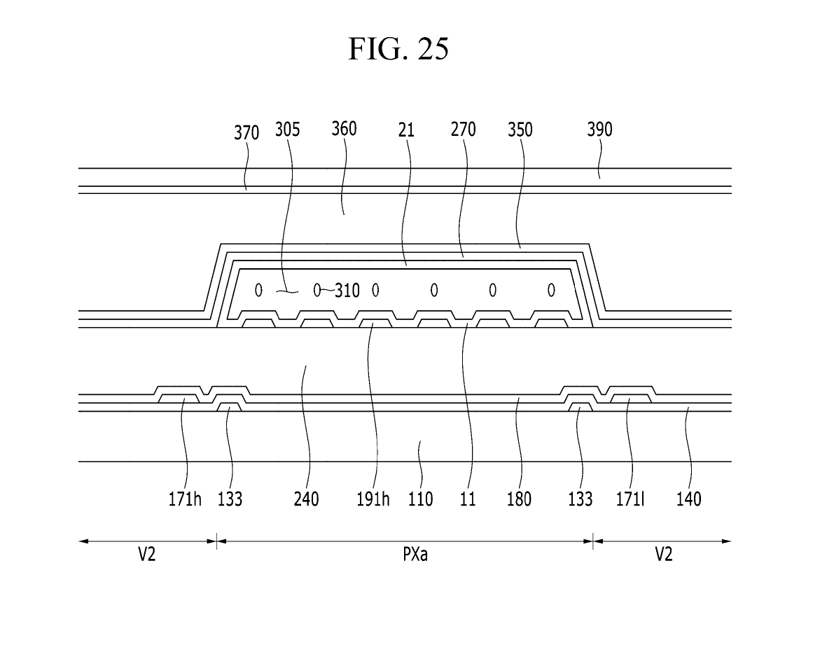

FIG. 7 to FIG. 25 are cross-sectional views of a manufacturing method of a display device, according to an exemplary embodiment. FIG. 7, FIG. 9, FIG. 11, FIG. 14, FIG. 17, FIG. 20, FIG. 22, and FIG. 24 are cross-sectional views cut along the same direction of FIG. 4. FIG. 8, FIG. 10, FIG. 12, FIG. 15, FIG. 18, FIG. 21, FIG. 23, and FIG. 25 are cross-sectional views cut along the same direction of FIG. 6. FIG. 13, FIG. 16, and FIG. 19 illustrates example photos in an actual process.

First, as shown in FIG. 7 and FIG. 8, a gate line 121 extending in a first direction and a first gate electrode 124h and second gate electrode 124l protruded from the gate line 121 are provided on a substrate 110. The substrate 110 may be made of glass or plastic. The first gate electrode 124h and the second gate electrode 124l may form a single protrusion by being connected with each other.

Further, a reference voltage line 131 and storage electrodes 133 and 135 protruded from the reference voltage line 131 may be formed together to be distanced from the gate line 121. The reference voltage line 131 may extend in a direction parallel to the gate line 121. The storage electrode 133 protruded above the reference voltage line 131 surrounds the edge of a first subpixel PXa, and the storage electrode 135 protruded below the reference voltage line 131 may be provided adjacent to the first gate electrode 124h and the second gate electrode 124l.

Next, a gate insulating layer 140 is formed using an inorganic insulating material such as a silicon nitride (SiNx), a silicon oxide (SiOx), and the like on the gate line 121, the first gate electrode 124h, the second gate electrode 124l, the reference voltage line 131, and the storage electrodes 133 and 135. The gate insulating layer 140 may be provided as a single layer or a multilayer.

Next, a semiconductor material such as amorphous silicon, polycrystalline silicon, a metal oxide, and the like is deposited above the gate insulating layer 140 such that a first semiconductor 154h and a second semiconductor 154l are formed. The first semiconductor 154h may overlap the first gate electrode 124h, and the second semiconductor 154l may overlap the second gate electrode 124l.

In one embodiment, after the first semiconductor 154h and the second semiconductor 154l are formed, the metal material is deposited and patterned such that a first data line 171h and a second data line 171l extending in a second direction are formed. The second direction may be perpendicular to the first direction. The metal material may be provided as a single layer or a multilayer.

Further, a first source electrode 173h protruded above the first gate electrode 124h from the first data line 171h and a first drain electrode 175h distanced from the first source electrode 173h are formed together. In addition, a second source electrode 173l protruded above the second gate electrode 124l from the second data line 171l and a second drain electrode 175l distanced from the second source electrode 173l are formed together.

In some embodiments, the semiconductor material and the metal material may be sequentially deposited and simultaneously patterned to form the first and second semiconductors 154h and 154l, the first and second data lines 171h and 171l, the first and second source electrodes 173h and 173l, and the first and second drain electrodes 175h and 175l. In this case, the first semiconductor 154h is provided below the first data line 171h, and the second semiconductor 154l is provided below the second data line 171l.

The first gate electrode 124h, the first source electrode 173h, and the first drain electrode 175h form the first thin film transistor Qh together with the first semiconductor 154h. In addition, the second gate electrode 124l, the second source electrode 173l, and the second drain electrode 175l form the second thin film transistor Q1 together with the second semiconductor 154l.

Next, a passivation layer 180 is provided above the first semiconductor 154h exposed between the first data line 171h, the second data line 171l, the first source electrode 173h, the first drain electrode 175h, the first source electrode 173h. In addition, the passivation layer 180 is provided above the second semiconductor 154l exposed between the second source electrode 173l, the second drain electrode 175l, the second source electrode 173l, and the second drain electrode 175l. The passivation layer 180 may be made of an inorganic insulating material.

A first insulating layer 240 is provided on the passivation layer 180. The first insulating layer 240 is made of an organic insulating material.

A mask 500 is placed correspondingly above the first insulating layer 240 and then an exposure process is performed. The mask 500 may be provided as a slit mask or a halftone mask. The mask 500 includes a non-transmissive portion NR that blocks all or most of the light, a half-transmissive portion HR that transmits a part of light, and a transmissive portion TR that transmits all or most of the light. When the mask 500 is provided as a slit mask, the half-transmissive portion HR may be formed in the shape of a slit.

The non-transmissive portion NR substantially corresponds to a pixel PX and a second region V2, the half-transmissive portion HR corresponds to a first region V1 and a partial edge of the pixel PX, and the transmissive portion TR corresponds to the first drain electrode 175h and a part of the second drain electrode 175l.

Light is hardly exposed to a portion of the first insulating layer 240 that corresponds to the non-transmissive portion NR of the mask 500, light is partially exposed to a portion of the first insulating layer 240 that corresponds to the half-transmissive portion HR, and light is mostly exposed to a portion of the first insulating layer 240 that corresponds to the transmissive portion TR.

As shown in FIG. 9 and FIG. 10, the first insulating layer 240 that has undergone the exposure process is developed for patterning. When the first insulating layer 240 includes a positive photosensitive material, the portion exposed to the light is eliminated, the portion partially exposed to the light becomes thinner, and the portion not exposed to the light remains as is. However, the present disclosure is not limited thereto, and the first insulating layer 240 may include a negative photoresist. In this case, a different mask 500 may be used. Further, the first insulating layer 240 may not include a photosensitive material. In this case, after coating a separate photoresist on the first insulating layer 240, the photoresist is patterned and then the first insulating layer 240 may be etched using the patterned photoresist as a mask.

In addition, the passivation layer 180 is patterned using the patterned first insulating layer 240 as a mask. The first insulating layer 240 and the passivation layer 180 are patterned to form a first contact hole 181h and a second contact hole 181l in the first insulating layer 240 and the passivation layer 180, and a trench 243 is provided in the first insulating layer 240. The first contact hole 181h exposes at least a part of the first drain electrode 175h, and the second contact hole 181l exposes at least a part of the second drain electrode 175l. The trench 243 is provided in the first region V1. A boundary of the trench 243 may match a boundary of the first region V1 or may be disposed inside or outside of the first region V1. For example, the trench 243 may be provided at an edge of the first subpixel PXa and the second subpixel PXb.

The first insulating layer 240 may be made of an organic material. In this case, the first insulating layer 240 has a relatively thicker thickness compared to a case where the first insulating layer 240 is made of an inorganic material. Accordingly, the upper surface can be substantially flattened. The height of the upper surface of the first insulating layer 240 in a portion where the trench 243 is formed is lower than other portions. That is, the height of the bottom surface of the trench 243 is lower than the height of a portion of the first insulating layer 240 that overlaps the microcavity 305. Referring to FIG. 4, the thickness t2 of a portion of the first insulating layer 240 where the trench 243 is formed is thinner than the thickness t1 of a portion of the first insulating layer 240 where the trench 243 is not formed. For example, a ratio of the thickness t2 compared to the thickness t1 is about 20% or more and about 90% or less. Further, a step formed between the portion where the trench 243 is formed in the first insulating layer 240 and the portion where the trench 243 is not formed in the first insulating layer 240 may be between about 0.5 μm or more and about 5 μm or less. That is, the depth of the trench 243 may be about 0.5 μm or more and about 5 μm or less.

In one embodiment, the first insulating layer 240 is made of a single insulating material, but the present disclosure is not limited thereto. The first insulating layer 240 may be formed using a plurality of color filters.

The plurality of color filters may include a red filter, a green filter, and a blue filter. Color filters of the same color may be provided along a column direction of the plurality of pixels PX. When color filters of three colors are provided, a first color filter is formed first using a mask, a second color filter is formed by shifting the mask, and a third color filter is formed by shifting the mask again. In the second region V2, neighboring color filters overlap each other to prevent light leakage.

The first insulating layer 240 may be made of an organic insulating material, but the present disclosure is not limited thereto. In some embodiments, the first insulating layer 240 may be a multilayer including a layer of an inorganic insulating material and another layer of an organic insulating material. The two insulating materials may be patterned to form the first insulating layer 240.

As shown in FIG. 11 and FIG. 12, a transparent metal material such as indium tin oxide (ITO), indium zinc oxide (IZO), and the like is deposited on the first insulating layer 240 and patterned to form a pixel electrode 191 in each pixel PX. The pixel electrode 191 includes a first subpixel 191h provided in the first subpixel PXa and a second subpixel electrode 191l provided in the second subpixel PXb. The first subpixel electrode 191h and the second subpixel electrode 191l may be separated from each other on a plane, interposing the first region V1 therebetween. The first subpixel electrode 191h is connected with the first drain electrode 175h through a first contact hole 181h, and the second subpixel electrode 191l is connected with the second drain electrode 175l through a second contact hole 181l.

Horizontal stems 193h and 193l and vertical stems 192h and 192l that cross the horizontal stems 193h and 193l are provided in each of the first and second subpixel electrodes 191h and 191l. Further, a plurality of minute branches 194h and 194l that are obliquely extended from the horizontal stems 193h and 193l and the vertical stems 192h and 192l are provided.

FIG. 13 is an example photo illustrating a state in which the first insulating layer 240 is provided above the substrate 110. The trench 243 is formed in the first insulating layer 240.

As shown in FIG. 14 and FIG. 15, a light blocking member 220 is formed using a material that can block light above the first insulating layer 240 and the pixel electrode 191. The light blocking member 220 is provided in the pixel PX, the first region V1, and the second region V2. Thus, the light blocking member 220 is provided in the trench 243 and may be provided above the first insulating layer 240 disposed outside of the trench 243. The light blocking member 220 may be made of an organic material, and may be planarized.

FIG. 16 is an example photo illustrating a state in which the light blocking member 220 is provided above the first insulating layer 240. The light blocking member 220 fills the trench 243, and is planarized. Further, the thickness of a portion of the light blocking member 220 in the trench 243 is relatively thicker than the thickness of other portions.

As shown in FIG. 17 and FIG. 18, the light blocking member 220 is developed to make the light blocking member 220 to remain only in the trench 243. After forming the light blocking member 220 above the first insulating layer 240 and the pixel electrode 191, a developing process can be performed without exposing the light blocking member 220. The light blocking member 220 may include a negative photoresist. A portion of the negative photoresist where light is not irradiated is eliminated during a developing process. In some embodiments, the light blocking member 220 may not undergo an exposure process.

The thickness of the light blocking member 220 can be adjusted by adjusting a processing time of the exposure. The light blocking member 220 can be continuously developed until all of the light blocking member 220 disposed outside of the trench 243 is eliminated. That is, the light blocking member 220 can be developed until the light blocking member 220 remains only in the trench 243.

The light blocking member 220 remains in the first region V1, and overlaps the first thin film transistor Qh and the second thin film transistor Ql. The light blocking member 220 can prevent light leakage in the first region V1. The light blocking member 220 may be entirely formed in the first region V1, and may overlap a part of the edge of the pixel PX. The light blocking member 220 is formed to fill the trench 243, and may not be provided outside of the trench 243. The upper surface of the first insulating layer 240 and the upper surface of the light blocking member 220 may be planarized. The height of the upper surface of the light blocking member 220 may be lower than or equal to that of the upper surface of a portion of the first insulating layer 240 where the trench 243 is not provided. That is, the height of the upper surface of the light blocking member 220 is lower than or equal to the height of the upper surface of a portion of the first insulating layer 240 that overlaps the microcavity 305. In this case, the height of the upper surface of the light blocking member 220 may be defined as a distance between the upper surface of the substrate 110 and the upper surface of the light blocking member 220, and the height of the first insulating layer 240 may be defined as a distance between the upper surface of the substrate 110 and the upper surface of the first insulating layer 240.

The trench 243 is formed in the first insulating layer 240, and the light blocking member 220 is formed above the first insulating layer 240. In the present exemplary embodiment, a developing process may be performed without performing an exposure process such that the light blocking member 220 can be patterned to remain only in the trench 243. Thus, a separate mask for forming the light blocking member 220 is not used, thereby saving the cost and processing time. However, the present disclosure is not limited thereto, and the light blocking member 220 can be patterned by using a separate mask. In this case, the light blocking member 220 may include a positive photoresist or a negative photoresist. When the light blocking member 220 is formed of a positive photoresist, a front side exposure process is performed and then a development process is performed such that the light blocking member 220 can be patterned to remain only in the trench 243.

FIG. 19 is an example photo illustrating a state in which the light blocking member 220 is developed and then patterned, without undergoing the exposure process.

The light blocking member 220 disposed outside of the trench 243 is eliminated, and the light blocking member 220 remains only in the trench 243. Further, the upper surface of the first insulating layer 240 and the upper surface of the light blocking member 220 are planarized.

As shown in FIG. 20 and FIG. 21, a sacrificial layer 300 is provided above the first insulating layer 240, the pixel electrode 191, and the light blocking member 220. The sacrificial layer 300 is provided in each pixel PX and the first region V1, and may not be provided in the second region V2.

A transparent metal material such as indium tin oxide (ITO), indium zinc oxide (IZO), and the like is deposited on the sacrificial layer 300 and the first insulating layer 240, and a common electrode 270 is formed.

Subsequently, a second insulating layer 350 is deposited on the common electrode 270. The second insulating layer 350 may be made of an inorganic insulating material such as silicon oxide (SiOx) or silicon nitride (SiNx).

A roof layer 360 is formed by coating an organic material on the second insulating layer 350. That is, after patterning the sacrificial layer 300, the common electrode 270, the second insulating layer 350, and the roof layer 360 are sequentially layered.

The roof layer 360 may be made of a single organic insulating material, but the present disclosure is not limited thereto. In some embodiments, the roof layer 360 may be formed of a plurality of color filters instead of the first insulating layer 240 being formed of color filters.

As shown in FIG. 22 and FIG. 23, the roof layer 360 that is disposed in the first region V1 is patterned to be eliminated. Accordingly, the roof layer 360 is formed in a shape that is connected along a plurality of pixel rows. After patterning the roof layer 360, light is irradiated to the roof layer 360 to perform a curing process. The roof layer 360 having undergone the curing process becomes rigid such that the roof layer 360 can maintain the shape of the microcavity 305 formed therebelow.

The second insulating layer 350 and the common electrode 270 are patterned using the roof layer 360 as a mask to eliminate the second insulating layer 350 and the common electrode 270 disposed in the first region V1.

A third insulating layer 370 is deposited on the roof layer 360. The third insulating layer 370 may be made of an inorganic insulating material such as a silicon nitride (SiNx), a silicon oxide (SiOx), and the like. The third insulating layer 370 is patterned to eliminate a portion disposed in the first region V1.

As the roof layer 360, the second insulating layer 350, the common electrode 270, and the third insulating layer 370 are patterned, the sacrificial layer 300 disposed in the first region V1 is exposed to the outside.

The sacrificial layer 300 may be entirely eliminated by supplying a developing solution or a striper solution onto the substrate 110 where the sacrificial layer 300 is exposed, or by using an ashing process. When the sacrificial layer 300 is eliminated, a microcavity 305 is provided in a space where the sacrificial layer 300 was present.

The pixel electrode 191 and the roof layer 360 are separated from each other, interposing the microcavity 305 therebetween. The roof layer 360 covers the upper surface and lateral side surfaces of the microcavity 305.

The microcavity 305 is exposed to the outside through portions where the roof layer 360 and the common electrode 270 are eliminated, and the exposed portions of the microcavity 305 are respectively called injection holes 307a and 307b. Two injection holes 307a and 307b may be formed in a single microcavity 305. For example, a first injection hole 307a exposes a side surface of a first edge of the microcavity 305, and a second injection hole 307b exposes a side surface of a second edge of the microcavity 305. The first edge and the second edge face each other. For example, the first edge may be an upper edge of the microcavity 305 and the second edge may be a lower edge of the microcavity 305.

As shown in FIG. 24 and FIG. 25, an aligning agent including an aligning material is deposited on the substrate 110 using a spin coating method or an inkjet method. The aligning agent is injected into the microcavity 305 through the injection holes 307a and 307b. When a curing process is performed, a liquid component is evaporated, and the aligning material remains in the inner wall surface of the microcavity 305.

A first alignment layer 11 may be provided on the pixel electrode 191, and a second alignment layer 21 may be provided below the common electrode 270. The first alignment layer 11 and the second alignment layer 21 face each other, interposing the microcavity 305 therebetween, and they may be connected with each other at an edge side wall of the microcavity 305. In this case, the first and second alignment layers 11 and 21 may be aligned along a direction that is perpendicular to the substrate 110, except for the side surfaces of the microcavity 305.

When a liquid crystal material is deposited on the substrate 110 using an inkjet method or a dispensing method, the liquid crystal material is injected into the microcavity 305 through the injection holes 307a and 307b by a capillary force. Accordingly, a liquid crystal layer filled with liquid crystal molecules 310 is formed in the microcavity 305.

In the present exemplary embodiment, the trench 243 is provided in the first insulating layer 240, and the light blocking member 220 is provided in the trench 243. The first insulating layer 240 and the light blocking member 220 respectively have flat upper surfaces. Thus, the injection holes 307 and 307b can be prevented from being reduced in size due to the light blocking member 220, and the aligning material or liquid crystal material can be easily injected through the injection holes 307a and 307b.

A material that does not react with the liquid crystal molecules 310 is deposited above the third insulating layer 370 to form an encapsulation layer 390. Since the encapsulation layer 390 is provided to cover the injection holes 307a and 307b, the encapsulation layer 390 seals the microcavity 305 such that the liquid crystal molecules 310 in the microcavity 305 can be prevented from being leaked to the outside.

Next, although it is not illustrated, a polarizer may be further attached to upper and lower surfaces of the display device. The polarizer may include a first polarizer and a second polarizer. The first polarizer may be attached to the lower surface of the substrate 110, and the second polarizer may be attached above the encapsulation layer 390.

While the disclosure has been described in connection with exemplary embodiments, it is to be understood that the present disclosure is not limited to the disclosed exemplary embodiments, but, on the contrary, is intended to cover various modifications and equivalent arrangements included within the spirit and scope of the present disclosure.

<Description of symbols>

| | | | |
|---|---|---|---|
| 110: | substrate | 121: | gate line |
| 171: | data line | 191: | pixel electrode |
| 220: | light blocking member | 240: | first insulating layer |
| 243: | trench | 270: | common electrode |
| 305: | microcavity | 310: | liquid crystal molecule |
| 360: | roof layer | 390: | encapsulation layer |
| 500: | mask | | |

What is claimed is:

1. A display device comprising:
a substrate;
a thin film transistor provided above the substrate;
a pixel electrode connected with the thin film transistor;
an insulating layer provided between the thin film transistor and the pixel electrode;
a trench provided in a portion of the insulating layer;
a light blocking member provided in the trench;
a roof layer provided above the pixel electrode to be separated from the pixel electrode, interposing a plurality of microcavities therebetween;
a liquid crystal layer provided in the plurality of microcavities; and
an encapsulation layer covering the plurality of microcavities.

2. The display device of claim 1, wherein the insulating layer is made of an organic insulating material.

3. The display device of claim 2, further comprising:
a first region provided between microcavities that are adjacent to each other along a column direction, and
a second region provided between microcavities that are adjacent to each other along a row direction,
wherein the trench is provided in the first region.

4. The display device of claim 1, wherein a first height of the trench is lower than a second height of a portion of the insulating layer that overlaps the plurality of microcavities.

5. The display device of claim 1, wherein a first thickness of the insulating layer where the trench is formed is thicker than a second thickness of the insulating layer where the trench is not formed.

6. The display device of claim 5, wherein a ratio of the first thickness to the second thickness of the insulating layer is 20% or more and 90% or less.

7. The display device of claim 1, wherein a depth of the trench is 0.5 μm or more and 5 μm or less.

8. The display device of claim 1, wherein an upper surface of the insulating layer and an upper surface of the light blocking member are planarized.

9. The display device of claim 1, wherein a first height of the upper surface of the light blocking member is lower than or equal to a second height of the upper surface of a portion of the insulating layer that overlaps the plurality of microcavities.

10. The display device of claim 1, wherein the light blocking member comprises a negative photoresist.

11. A method for manufacturing a display device, comprising:
forming a thin film transistor on a substrate;
forming an insulating layer on the thin film transistor;
forming a trench by patterning a portion of the insulating layer;
forming a pixel electrode on the insulating layer, wherein the pixel electrode is connected with the thin film transistor;
forming a light blocking member in the trench;
forming a sacrificial layer on the insulating layer, the pixel electrode, and the light blocking member;
forming a roof layer on the sacrificial layer;
forming injection holes that partially expose the sacrificial layer by patterning the roof layer;
forming microcavities between the pixel electrode and the roof layer by eliminating the sacrificial layer;
forming a liquid crystal layer by injecting a liquid crystal material into the microcavities through the injection holes; and
sealing the microcavities by forming an encapsulation layer on the roof layer.

12. The method for manufacturing the display device of claim 11, wherein the forming the light blocking member in the trench comprises:
forming the light blocking member on the insulating layer and the pixel electrode; and
developing the light blocking member.

13. The method for manufacturing the display device of claim 12, wherein the light blocking member is developed until the light blocking member remains only in the trench.

14. The method for manufacturing the display device of claim 12, wherein the light blocking member is developed until the light blocking member disposed outside of the trench is eliminated.

15. The method for manufacturing the display device of claim 12, wherein, in the forming of the light blocking member in the trench, the light blocking member is developed without undergoing an exposure process.

16. The method for manufacturing the display device of claim 12, wherein the light blocking member comprises a negative photoresist.

17. The method for manufacturing the display device of claim 11, wherein the insulating layer is made of an organic insulating material.

18. The method for manufacturing the display device of claim 11, wherein the display device further comprises a first region provided between microcavities that are adjacent to each other along a column direction, and a second region provided between microcavities that are adjacent to each other along a row direction,
wherein the trench is provided in the first region.

19. The method for manufacturing the display device of claim 11, wherein a first height of the trench is lower than a second height of a portion of the insulating layer that overlaps the microcavities.

20. The method for manufacturing the display device of claim 11, wherein a ratio of a first thickness of the insulating layer where the trench is formed to a second thickness of the insulating layer where the trench is not formed is 20% or more and 90% or less.
